(19) United States
(12) Patent Application Publication
(10) Pub. No.: US 2013/0043296 A1
(43) Pub. Date: Feb. 21, 2013

(54) AUTOMATIC TORCH FLUXING APPARATUS

(71) Applicant: Timothy Andrecheck, Chittenango, NY (US)

(72) Inventor: Timothy Andrecheck, Chittenango, NY (US)

(73) Assignee: CARRIER CORPORATION, Farmington, CT (US)

(21) Appl. No.: 13/586,370

(22) Filed: Aug. 15, 2012

Related U.S. Application Data
(60) Provisional application No. 61/524,065, filed on Aug. 16, 2011.

(51) Int. Cl. B23K 3/08

(52) U.S. Cl. 228/33

(57) ABSTRACT

An automatic torch fluxing apparatus is provided and includes a supply of fuel, a flux container formed to define a reservoir of non-corrosive flux for aluminum brazing, the reservoir being receptive of the fuel whereby the fuel and the flux form a fuel/flux mixture and a torch to which the fuel/flux mixture is deliverable, the torch being configured to ignite the fuel in the fuel/flux mixture to form a flux enriched flame.

### BACKGROUND OF THE INVENTION

Aspects of the present invention are directed to an automatic torch fluxing apparatus to apply flux to rings used in brazing round tube plate fin (RTPF) heat exchanger coils in, for example, heating, ventilation, air conditioning and refrigeration products.

Currently, commercially available braze rings for automatic brazing of RTPF heat exchanger coils are made of Al—Zn or Al—Si filler material. Some are solid rings, some others pre-fluxed. Tests have shown that none of them performs as well as an Al—Zn—Si ring when a correct amount of flux is applied to the joint. Manual fluxing can ensure the correct amount of flux is applied. With high through-put assemblies, however, manual fluxing cannot keep up with capacity demands.

### BRIEF DESCRIPTION OF THE INVENTION

An automatic torch fluxing apparatus is provided and includes a supply of fuel, a flux container formed to define a reservoir of non-corrosive flux for aluminum brazing, the reservoir being receptive of the fuel whereby the fuel and the flux form a fuel/flux mixture and a torch to which the fuel/flux mixture is deliverable, the torch being configured to ignite the fuel in the fuel/flux mixture to form a flux enriched flame.

An automatic torch fluxing apparatus is provided and includes a supply of fuel, a flux container formed to define a reservoir of non-corrosive flux for aluminum brazing, a first conduit coupled to the fuel supply and the flux container by which the fuel is transported from the fuel supply into and through the flux container whereby the fuel is mixed with the flux to form a fuel/flux mixture, a second conduit coupled to the flux container by which the fuel/flux mixture is transported from the flux container and a torch coupled to the second conduit to ignite the fuel in the fuel/flux mixture to form a flux enriched flame.

An automatic torch fluxing apparatus is provided and includes a supply of fuel, a flux container formed to define a reservoir of non-corrosive flux for aluminum brazing, a first conduit coupled to the fuel supply and the flux container by which the fuel is transported from the fuel supply into and through the flux container whereby the fuel is mixed with the flux to form a fuel/flux mixture, a second conduit coupled to the flux container by which the fuel/flux mixture is transported from the flux container and a torch coupled to the second conduit to ignite the fuel in the fuel/flux mixture to form a flux enriched flame.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an automatic torch fluxing apparatus.

### DETAILED DESCRIPTION OF THE INVENTION

In accordance with aspects of the invention, fuel gases (i.e., natural gas, propylene, acetylene, propane) are allowed to pass through a reservoir of non-corrosive flux designed for brazing aluminum coils in an autobraze environment or in robotic braze equipment. The fuel gas acts as a carrier for the flux, which is pressurized and carried to the joint to be brazed. The operator or automatic brazing station will have the required amount of flux carried to the joint. Flux will be metered in selected amounts to braze a joint evenly and completely.

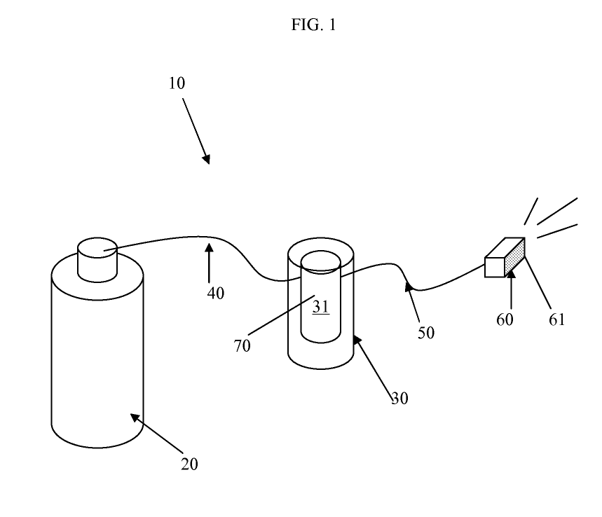

With reference to FIG. 1, an automatic torch fluxing apparatus 10 is provided. The apparatus 10 includes a fuel tank 20 providing a supply of fuel, a flux container 30 formed to define a reservoir of non-corrosive flux for aluminum brazing in an interior 31 therein, first and second conduits 40, 50 and a torch 60. The first conduit 40 is coupled to the fuel tank 20 at a first end thereof and to the flux container 30 at a second end thereof and provides a transport mechanism by which the fuel is transported from the fuel tank 20 into and through the flux container 30. Fuel received in the flux container 30 is mixed with the flux to form a fuel/flux mixture. More particularly, the flux material, which may be a liquid, is pressurized and mixed with the fuel.

The second conduit 50 is coupled to the flux container 30 at a first end thereof and to the torch 60 at a second end thereof and provides a transport mechanism by which the fuel/flux mixture is transported from the flux container 30 to the torch 60. The torch 60 serves to ignite the fuel in the fuel/flux mixture to form a flux enriched flame. More particularly, heat provided by the torch will activate the flux in the fuel/flux mixture. By directing the flux enriched flame at the joint area, the activated flux will evenly and completely coat the joint area to achieve robust, high quality fluxing and/or brazing.

In accordance with embodiments, the fuel may include one or more of natural gas, propylene, acetylene and propane or another similar fuel in gaseous or liquid form. Also, the torch 60 may include a nozzle 61 or a plurality of nozzles 61 arranged in a predefined array appropriate for a given application. Still further, the apparatus 10 may include a metering unit 70 to control an amount of the flux in the fuel/flux mixture. As shown in FIG. 1, the metering unit 70 may be included within the flux container 30, for example. In further examples, the metering unit 70 may be operably disposed along the first conduit 40, the second conduit 50 or at one of the intersections of the first conduit 40 or the second conduit 50 with the flux container 30.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An automatic torch fluxing apparatus, comprising:
a supply of fuel;
a flux container formed to define a reservoir of non-corrosive flux for aluminum brazing, the reservoir being receptive of the fuel whereby the fuel and the flux form a fuel/flux mixture; and
a torch to which the fuel/flux mixture is deliverable, the torch being configured to ignite the fuel in the fuel/flux mixture to form a flux enriched flame.

2. The automatic torch fluxing apparatus according to claim 1, further comprising a fuel tank providing the supply of the fuel.

3. The automatic torch fluxing apparatus according to claim 1, wherein the fuel comprises at least one or more of natural gas, propylene, acetylene and propane.

4. The automatic torch fluxing apparatus according to claim 1, further comprising a metering unit to control an amount of flux in the fuel/flux mixture.

5. An automatic torch fluxing apparatus, comprising:
a flux container;
a first conduit coupled to the flux container by which fuel is transported into and through the flux container whereby the fuel and flux contained within the flux container form a fuel/flux mixture;
a second conduit coupled to the flux container by which the fuel/flux mixture is transported from the flux container; and
a torch coupled to the second conduit to ignite the fuel in the fuel/flux mixture to form a flux enriched flame.

6. The automatic torch fluxing apparatus according to claim 5, further comprising a fuel tank providing a supply of the fuel.

7. The automatic torch fluxing apparatus according to claim 6, wherein the first conduit is coupled to the fuel tank.

8. The automatic torch fluxing apparatus according to claim 5, wherein the fuel comprises one of natural gas, propylene, acetylene and propane.

9. The automatic torch fluxing apparatus according to claim 5, wherein the flux comprises a non-corrosive flux for aluminum brazing.

10. The automatic torch fluxing apparatus according to claim 5, wherein the torch comprises a nozzle.

11. The automatic torch fluxing apparatus according to claim 5, wherein the torch comprises a plurality of nozzles.

12. The automatic torch fluxing apparatus according to claim 5, further comprising a metering unit to control an amount of flux in the fuel/flux mixture.

13. An automatic torch fluxing apparatus, comprising:
a supply of fuel;
a flux container formed to define a reservoir of non-corrosive flux for aluminum brazing;
a first conduit coupled to the fuel supply and the flux container by which the fuel is transported from the fuel supply into and through the flux container whereby the fuel is mixed with the flux to form a fuel/flux mixture;
a second conduit coupled to the flux container by which the fuel/flux mixture is transported from the flux container; and
a torch coupled to the second conduit to ignite the fuel in the fuel/flux mixture to form a flux enriched flame.

14. The automatic torch fluxing apparatus according to claim 13, further comprising a fuel tank providing the supply of the fuel.

15. The automatic torch fluxing apparatus according to claim 14, wherein the first conduit is coupled to the fuel tank.

16. The automatic torch fluxing apparatus according to claim 13, wherein the fuel comprises one of natural gas, propylene, acetylene and propane.

17. The automatic torch fluxing apparatus according to claim 13, wherein the torch comprises a nozzle.

18. The automatic torch fluxing apparatus according to claim 13, wherein the torch comprises a plurality of nozzles.

19. The automatic torch fluxing apparatus according to claim 13, further comprising a metering unit to control an amount of flux in the fuel/flux mixture.
